(19) United States
(12) Patent Application Publication
(10) Pub. No.: US 2005/0234180 A1
(43) Pub. Date: Oct. 20, 2005

(54) Resin molded article

(76) Inventors: Satoru Ono, Aichi-ken (JP); Yoshiaki Kameda, Aichi-ken (JP); Seiichi Arakawa, Ube (JP); Tadashi Ogawa, Ube (JP)

Correspondence Address: POSZ LAW GROUP, PLC, 12040 SOUTH LAKES DRIVE, SUITE 101, RESTON, VA, 20191, US

(21) Appl. No.: 11/108,907

(22) Filed: Apr. 19, 2005

(30) Foreign Application Priority Data
Apr. 20, 2004 (JP) JP 2004-123746

(51) Int. Cl. C08K 3/34

(52) U.S. Cl. 524/451

(57) ABSTRACT

A resin molded article having an excellent molding performance and an excellent snow melting salt resistance is provided. The present invention is a resin molded article having an excellent snow melting salt resistance. An outer layer portion comprises 100 parts by weight of a polyamide resin and 3 to 40 parts by weight of an impact resistant material. The polyamide resin essentially consists of 40 to 99% by weight of polyamide 66 and 1 to 60% by weight of aromatic polyamide resin.

### CROSS-REFERENCES TO RELATED APPLICATIONS

The present application claims priority under 35 U.S.C. § 119 to Japanese Patent Application No. 2004-123746, filed Apr. 20, 2004, entitled “RESIN MOLDED ARTICLE”. The contents of this application are incorporated herein by reference in their entirety.

### BACKGROUND OF THE INVENTION

1. Field of the Invention

The present invention relates to a resin molded article having an excellent snow melting salt resistance.

2. Discussion of the Background

Recently, automobiles, electric and electronic parts and the like employ resin molded article made from polyamide resins and the like for the purpose of reducing weights or costs. Especially in the case of a resin molded article employed in an automobile engine room, a product is required which undergoes no deterioration of the characteristics such as a strength even at an elevated temperature of an engine coolant or engine room accompanying to a higher engine performance and a higher engine power and also undergoes no deformation whereby being resistant to a severe operating condition. On the other hand, a snow melting agent consisting of a metal salt such as calcium chloride employed in a cold district for the purpose of preventing a road freezing causes a requirement of a resin molded article having an excellent resistance against such a snow melting salt. Moreover, a material showing an excellent molding performance is required for the purpose of being applicable to products of various shapes.

A conventional resin molded article applied to an automobile part and the like may for example be a resin molded article made from polyamide 6 or polyamide 66. Such a resin molded article may for example be a resin pipe (see Patent documents 1 and 2). To be more precise, Patent documents 1 shows a three-layered resin pipe comprising an outer layer made from polyamide 612 resin and a modified polyolefin resin, an intermediate layer made from an acid-modified polyolefinic hot melt and an inner layer made from a crosslinked polyethylene. Patent documents 2 shows a resin pipe comprising an outer layer made from polyamide 6, polyamide 11 and polyamide 12, an intermediate layer made from PPS and polyamide 6 and an inner layer made from PPS.

Nevertheless, such a conventional resin molded article involves a possibility of forming a crack as a result of the deposition of a snow melting agent onto the resin molded article. Thus, its resistance to the snow melting agent is insufficient. Accordingly, any conventionally resin molded article was not necessarily suitable to an application to an automobile part and the like.

### SUMMARY OF THE INVENTION

Patent document 1: JP 2001-18307 Unexamined Patent Publication (Kokai)
Patent document 2: JP 2003-21275 Unexamined Patent Publication (Kokai)

The present invention has been made in consideration of such conventional problems, and an object of the present invention is to provide a resin molded article having an excellent molding performance and an excellent snow melting salt resistance.

A first aspect of the present invention is a resin molded article having an excellent snow melting salt resistance, the resin molded article comprising
an outer layer portion comprising 100 parts by weight of a polyamide resin and 3 to 40 parts by weight of an impact resistant material, and,
wherein the polyamide resin essentially consists of 40 to 99% by weight of polyamide 66 and 1 to 60% by weight of an aromatic polyamide resin.

A second aspect of the present invention is a resin molded article having an excellent snow melting salt resistance, the resin molded article comprising:
an outer layer portion comprising 100 parts by weight of a polyamide resin and 3 to 40 parts by weight of an impact resistant material, and,
wherein the polyamide resin essentially consists of 40 to 98.5% by weight of polyamide 66, 1 to 59.5% by weight of an aromatic polyamide resin and 0.5 to 20% by weight of polyamide 12.

In the both cases of the above first and second aspects of the present invention, it is possible to comprise the following two compositions.

That is, the resin molded article may consist of only the outer layer portion.

Further, the resin molded article may comprise a plural layers, an outermost layer thereof consisting of the outer layer portion.

### BRIEF DESCRIPTION OF THE DRAWINGS

FIG. 1 shows a explanation view of a resin molded article according to Example 2.

FIG. 2 shows a sectional view at A-A in the direction of arrows A in FIG. 1.

### DETAILED DESCRIPTION OF THE INVENTION

In the molded articles of the first and second aspects of the present invention, the outer layer portions comprise polyamide resins comprising polyamide 66 and aromatic polyamide resin in respective amounts specified above. As a result, a synergetic effect of polyamide 66 with aromatic polyamide resin allows the outer layer portion to exert an excellent resistance to a snow melting agent such as calcium chloride. Accordingly, the resin molded article undergoes almost no cracking even if the snow melting agent such as calcium chloride deposits onto the outer layer portion. Thus, the resin molded article is excellent in terms of the snow melting salt resistance.

On the other hand, a resin molded article of the present invention is excellent in terms of a high temperature rigidity and molding performance because its outer layer portion comprises the polyamide resin having a particular composition described above. Accordingly, the resin molded article can exert sufficiently excellent strength and elasticity even at a high temperature, and can be applicable to products of various shapes. As a result, it can be employed preferably for example in automobile parts and the like.

The outer layer portion also comprises an impact resistant material in an amount specified above. As a result, the impact resistance and the molding performance of the resin molded article can be improved.

In a resin molded article of the second aspect of the present invention, the polyamide resin constituting the outer layer portion also comprises polyamide 12 in an amount specified above. As a result, the strength of a weld, if any in the resin molded article, can be improved.

### DESCRIPTION OF THE PREFERRED EMBODIMENTS

In a resin molded article according to the first aspect of the present invention, the polyamide resin constituting the outer layer portion comprises 40 to 99% by weight of polyamide 66 and 1 to 60% by weight of aromatic polyamide resin. Preferably, 50 to 85% by weight of polyamide 66 and 15 to 50% by weight of aromatic polyamide resin are employed.

In a resin molded article according to the second aspect of the present invention, the polyamide resin constituting the outer layer portion comprises 40 to 98.5% by weight of polyamide 66, 1 to 59.5% by weight of aromatic polyamide resin and 0.5 to 20% by weight of polyamide 12. Preferably, 50 to 83% by weight of polyamide 66, 15 to 48% by weight of aromatic polyamide resin and 2 to 15% by weight of polyamide 12 are employed.

In both of the first and second aspects of the present invention, in the case that a content of a polyamide 66 is less than the lower limit described above, it gives a poor fluidity of a material upon producing a resin molded article described above, which may cause a poor molding performance, resulting in a poor appearance of the resin molded article. On the other hand, in the case that a content of a polyamide 66 is exceeding the upper limit described above, it leads to aromatic polyamide resin content becomes less than the lower limit described above, which may lead to a difficulty in obtaining a sufficient anti-snow melting salt effect attributable to the incorporation of aromatic polyamide resin.

Further, in the case that a content of aromatic polyamide resin is exceeding the upper limit described above, it gives a poor fluidity of a material upon molding, which may cause a poor molding performance, resulting in a poor appearance of the resin molded article. On the other hand, in the case that a content of aromatic polyamide resin is less than the lower limit described above, it may lead to a reduced snow melting salt resistance of a resin molded article described above. Furthermore in such a case, the welding performance or the weld strength may also reduced.

Further, in the case that a content of polyamide 12 in the second aspect of the present invention is exceeding the upper limit described above, it may lead to a reduced weld strength of a resin molded article. On the other hand, in the case that a content of polyamide 12 is less than the lower limit described above, it poses a problems such as a difficulty in obtaining an effective improvement in molding performance, low absorption ability and appearance.

While the polymerization degree of polyamide 66 employed in the present invention is not limited particularly, one having a relative viscosity of a solution of 1 g of the polymer dissolved in 100 ml of a 96% concentrated sulfuric acid ranges from 2.0 to 5.0 when measured at 25° C. The relative viscosity is more preferably 2.1 to 4.5, especially 2.2 to 3.5. In the case that a relative viscosity is higher than the upper limit described above, it leads to an extremely poor processing performance. On the other hand, in the case that a relative viscosity is less than the lower limit described above, it gives a problematically reduced mechanical strength. As used herein, polyamide 66 includes a copolymer containing a small amount (for example 10% by weight or less) of other polyamide structure units.

Aromatic polyamide resin employed in the present invention is aromatic polyamide resin containing at least one aromatic monomer component, and may for example be an equimolar salt of an aliphatic diamine with an aromatic dicarboxylic acid as well as a copolymeric polyamide thereof with an equimolar salt of an aliphatic diamine with an aliphatic dicarboxylic acid and/or an aliphatic polyamide-forming monomer.

An aliphatic diamine may for example be an aliphatic diamine having 4 to 12 carbon atoms such as tetramethylenediamine, hexamethylenediamine, octamethylenediamine, nonamethylenediamine, undecamethylenediamine, dodecamethylene diamine and the like, or an aromatic or cyclic diamine such as methaxylylenediamine and the like.

An aromatic dicarboxylic acid may for example be terephthalic acid, isophthalic acid, naphthalene dicarboxylic acid and the like.

An aliphatic dicarboxylic acid may for example be an aliphatic dicarboxylic acid having 6 to 12 carbon atoms such as adipic acid, heptane dicarboxylic acid, octane dicarboxylic acid, nonane dicarboxylic acid, undecane dicarboxylic acid, dodecane dicarboxylic acid and the like.

An aliphatic polyamide-forming monomer may for example be an aminocarboxylic acid having 6 to 12 carbon atoms and a lactam having 6 to 12 carbon atoms, such as 6-aminocaproic acid, 7-aminoheptanoic acid, 11-aminoundecanoic acid, 12-aminododecanoic acid, α-pyrrolidone, ε-caprolactam, laurolactam, ε-enantholactam and the like, with 6-aminocaproic acid, 12-aminododecanoic acid, ε-caprolactam, laurolactam being preferred. An aliphatic polyamide-forming monomer may be employed alone or in combination with other such components.

Aromatic polyamide resin described above is preferably an amorphous semi-aromatic copolyamide resin containing at least two aromatic monomer components. An amorphous semi-aromatic copolyamide resin is preferably an amorphous polyamide whose glass transition temperature determined on the basis of the peak temperature of the loss elasticity at absolute drying obtained by measuring a dynamic viscoelastivity is 100° C. or higher.

As used herein, the term “amorphous” corresponds to a crystalline fusion calorie measured by a differential scanning calorimeter (DSC) which is 1 cal/g or less.

The amorphous semi-aromatic copolyamide resin described above is preferably one comprising 40 to 95% by mole of a terephthalic acid component unit, 5 to 60% by mole of an isophthalic acid component unit and an aliphatic diamine. A preferable combination is an equimolar salt of hexamethylene diamine and terephthalic acid and an equimolar salt of hexamethylene diamine and isophthalic acid.

One employed preferably comprises 99 to 60% by weight of a polyamide-forming component comprising of an aliphatic diamine, isophthalic acide and terephthalic acid and 1 to 40% by weight of an aliphatic polyamide.

While the polymerization degree of polyamide 12 employed in the present invention (second aspect of the present invention) is not limited particularly, it preferably has a relative viscosity of 1.8 to 5.0. As used herein, polyamide 12 includes a copolymer containing a small amount (for example 10% by weight or less) of other polyamide structure units.

The impact resistant material employed in the present invention may for example be one generally referred to as a rubber or an elastomer, and one exemplified typically is an impact resistant material including an olefinic elastomer such as EPR (ethylene-propylene copolymer), EPDM (ethylene-propylene-diene copolymer), EBR (ethylene-butylene copolymer), EOR (ethylene-octene copolymer) and the like, a styrenic elastomer such as SBS (styrene-butylene-styrene block copolymer), SEBS (styrene-ethylene-butylene-styrene block copolymer), SEPS (styrene-etylene-propylene-styrene block copolymer), SIS (styrene-isoprene-styrene copolymer) and the like, an α-olefin-(unsaturated carboxylic acid and/or unsaturated carboxylate ester)-based elastomer such as EEA (ethylene-ethyl acrylate copolymer), EMA (ethylene-methyl acrylate copolymer), EAA (ethylene-acrylic acid copolymer), EMAA (ethylene-methacrylic acid copolymer), EMMA (ethylene-methyl methacrylate copolymer) and the like, ionomers and the like, which may be used in combination of two or more. It is also preferable to subjecting such an impact resistant material to an acid modification using a dicarboxylic acid such as maleic acid and itaconic acid or an anhydride thereof for the purpose of obtaining a further excellent mechanical strength.

It is preferable that the impact resistant material is an acid-modified ethylene-butene copolymer (EBR), an acid-modified ethylene-propylene copolymer (EPR), an acid-modified ethylene-propylene-diene copolymer (EPDM) or an acid-modified styrene-ethylene-butylene-styrene block copolymer (SEBS).

An acid-modified EBR is further preferred.

The amount of the impact resistant material described above is 3 to 40 parts by weight, preferably 15 to 30 parts by weight, based on 100 parts by weight of a resultant polyamide resin. In the case that an amount is less than 3 parts by weight, it leads to insufficient molding performance and impact resistance. In the case that an amount is exceeding 40 parts by weight, it leads to a problematically poor mechanical strength, especially at an elevated temperature.

The resin molded article described above may be employed for example in an automobile part, electric or electronic part and the like.

In such a resin molded article, an outer layer portion exposed on the outermost surface comprises the polyamide resin described above. The resin molded article may be one consisting only of the outer layer portion described above or may be one formed from a combination of such an outer layer portion with other resins, or one formed by lamination.

It is preferable that the outer layer portion further comprises 2 to 150 parts by weight of an inorganic filler.

In such a case, the mechanical strength of a resin molded article described above can be improved.

In the case that an amount of an inorganic filler described above is less than 2 parts by weight, it may lead to a difficulty in obtaining a desired sufficient improvement in the mechanical strength. On the other hand, in the case that an amount is exceeding 150 parts by weight, it may lead to a poor molding performance upon producing the resin molded article described above and a poor surface condition. More preferably, such an inorganic filler is present in an amount of 3 to 40 parts by weight, more preferably 5 to 30 parts by weight based on 100 parts by weight of the polyamide resin described above.

The inorganic filler described above may for example be a fibrous or non-fibrous inorganic filler, typically including a fibrous filler such as glass fiber, carbon fiber, potassium titanate whisker, zinc oxide whisker, aluminum borate whisker, aramid fiber, alumina fiber, silicon carbide fiber, ceramic fiber, asbestos fiber, gypsum fiber, metal fiber and the like, a silicate such as wallastonite, zeolite, sericite, kaolin, mica, clay, pyrophylite, bentonite, montmorillonite, asbestos, talc, aluminosilicate and the like, a metal oxide such as alumina, silicone oxide, magnesium oxide, zirconium oxide, titanium oxide, iron oxide and the like, a carbonate such as calcium carbonate, magnesium carbonate, dolomite and the like, a sulfate such as calcium sulfate, barium sulfate and the like, a hydroxide such as magnesium hydroxide, calcium hydroxide, aluminum hydroxide, a non-fibrous filler such as glass bead, ceramic bead, boron nitride, silicon carbide, silica and the like. Any of these may be hollow, and two or more of these inorganic fillers may be employed in combination. It is also preferable for the purpose of obtaining a further excellent mechanical strength to subject such a filler to a preliminary treatment with a coupling agent such as an isocyanate-based compound, acrylic compound, organic silane-based compound, organic titanate-based compound, organic borane-based compound, epoxy compounds and the like.

It is preferable that the inorganic filler is a talc or wallastonite.

A talc has a mean particle size of 0.1 to 30 μm, preferably 0.1 to 10 μm. A wallastonite has a diameter of 0.1 to 50 μm, preferably 1 to 30 μm, and a length of 10 to 1000 μm, preferably 50 to 500 μm.

It is preferable that the resin molded article is a coolant system part and formed by combining an inner layer portion which is in contact with the coolant and the outer layer portion which is provided outside of the inner layer portion via an intermediate layer portion for adhesion.

In this case, the resin molded article has a combination of a property of the inner layer portion which is in contact with a coolant and a property of the outer layer portion. Accordingly, it is preferable that the resin molded article is a coolant system part which is in contact with a coolant for cooling an automobile engine.

The coolant system part described above may for example be a coolant system part in an engine, and is a part which is brought into contact with the coolant in an engine room. Typically, it is a radiator tank part such as radiator tank top and base, a cooling fluid reservoir tank, water pipe, water inlet pipe, water outlet pipe, water pump housing, water pump impeller, valve and the like.

The resin molded article described above can be employed also in a part required to have a function equivalent to the coolant system part described above, such as a floor heating water pipe and a snow melting road sprinkler pipe.

It is preferable that the inner layer portion comprising a polyphenylene sulfide.

In such a case, it is preferred to use the resin molded article described above as a coolant system part in an automobile engine. Thus, in such a case, the resistance to an antifreeze solution (LLC) employed in an engine coolant system whose main ingredient is ethylene glycol is excellent.

The inner layer portion described above may be one comprising a softening agent together with a polyphenylene sulfide.

It is preferable that the intermediate layer portion comprises a polyphenylene sulfide and a polyamide resin.

In such a case, the resin molded article described above becomes excellent in terms of the adhesiveness between the inner layer portion and the outer layer portion described above.

As the polyamide resin described above, a polyamide resin identical to that in the outer layer portion may be employed, although other various polyamide resins are applicable.

The outer layer portion according to the present invention may contain various functionalizing agents including a heat resistant agent, weather-resistance agent, nucleating agent, crystallization promoting agent, release agent, lubricant, antistatic agent, flame retardant, flame-resisting auxiliary, colorant and the like, as long as its objective is not affected adversely.

More typically, a heat resistant agent may for example be a hindered phenol, phosphite, thioether, halogenated copper and the like, which may be employed alone or in combination with each other.

A weather-resistance agent may for example be a hindered amine and salicylate, which may be employed alone or in combination with each other.

A nucleating agent may for example be an inorganic filler such as a talc or clay, or an organic nucleating agent such as a fatty acid metal salt and the like, which may be employed alone or in combination with each other.

A crystallization promoting agent may for example be a low molecular weight polyamide, higher fatty acid, higher fatty acid ester, higher aliphatic alcohol and the like, which may be employed alone or in combination with each other.

A release agent may for example be a fatty acid metal salt, fatty acid amide or any of various waxes, which may be employed alone or in combination with each other.

An antistatic agent may for example be an aliphatic alcohol, aliphatic alcohol ester and a higher fatty acid ester, which may be employed alone or in combination with each other.

A flame retardant may for example be a metal hydride such as magnesium hydroxide, phosphorus, ammonium phosphate, ammonium polyphosphate, melamine cyanurate, ethylene dimelamine dicyanurate, potassium nitrate, brominated epoxy compound, brominated polycarbonate compound, brominated polystyrene compound, tetrabromobenzyl polyacrylate, tribromophenol polycondensate, polybromobiphenyl ether or chlorine-based flame retardant and the like, which may be employed alone or in combination with each other.

The outer layer portion described above according to the present invention may contain other thermoplastic resins as long as an objective of the present invention is not affected adversely. Examples of thermoplastic resins employed in combination are versatile resin materials such as polyethylene, polypropylene, polystyrene, ABS resins, AS resin, acrylic resins and the like, aliphatic polyamide resins such as polyamide 6, polyamide 11 and the like, as well as polycarbonate, polyphenylene oxide, polyethylene terephthalate, polybutylene terephthalate, polyphenylene sulfide and other highly heat resistant resins. These are employed preferably after being subjected to a modification with maleic anhydride or glycidyl group-containing monomer, and especially when using a functional group-free substance such as polyethylene or polypropylene, it is more preferred to use one modified with maleic anhydride or glycidyl group-containing monomer.

The outer layer portion of the present invention may be formed by blending respective resin pellets and then melting and mixing at a stage of obtaining a final product, or may first be kneaded by a one-screw or twin-screw extruder, banbury mixer and the like and then molded. Thus, the use in an extrusion molding, blow molding or injection molding is possible. Especially, it is preferable that the resin molded article is an extrusion molded article.

### EXAMPLES

### Example 1

Examples of a resin molded article of the present invention are described below.

In this Example, 4 types of resin molded articles made from a polyamide resin as Examples (Samples E1 to E4) and 5 types as Comparatives (Samples C1 to C5) were produced and examined for their characteristics.

(Sample E1)

100 Parts by weight of a polyamide resin containing 65% by weight of polyamide 66 (UBE INDUSTRIES, LTD., 2020B), 31% by weight of Polyamide 6I/6T (EMS, GRIVORY G21) and 4% by weight of polyamide 12 (UBE INDUSTRIES, LTD., 3014U) was first mixed uniformly with 25 parts by weight of an ethylene-butene copolymer (MITSUI CHEMICALS, TAFMER MH5020), and then kneaded by a twin-screw extruder having 44 mmφ vent whose barrel temperature was set at 285° C. to obtain an intended polyamide resin composition pellet. The resultant pellet was then dried for 24 hours under reduced pressure of 10 torr at 110° C., and then injection molded at 285° C. as a cylinder temperature and 80° C. as a mold temperature, whereby producing each test piece, which was designated as Sample E1.

(Sample E2)

Each test piece made from a polyamide resin composition was produced similarly to Sample E1 except for changing the input ratio of polyamide 66, polyamide 6I/6T, polyamide 12 and ethylene-butene copolymer to that shown in Table 1, and was designated as Sample E2.

(Sample E3)

100 Parts by weight of a polyamide resin containing 64% by weight of polyamide 66 (UBE INDUSTRIES, LTD., 2020B), 32% by weight of Polyamide 6I/6T (EMS, GRIVORY G21) and 4% by weight of polyamide 12 (UBE INDUSTRIES, LTD., 3014U) was first mixed uniformly with 23 parts by weight of an ethylene-butene copolymer (MITSUI CHEMICALS, TAFMER MH5020), and then kneaded by a twin-screw extruder having 44 mmφ vent whose barrel temperature was set at 285° C. Upon kneading this polyamide resin, 100 parts by weight of the polyamide resin was supplemented halfway of the extruder with 6.5 parts by weight of a talc (NIPPON TALC, MICROACE L-1) to obtain an intended polyamide resin composition pellet. The resultant pellet was then dried for 24 hours under reduced pressure of 10 torr at 110° C., and then injection molded at 285° C. as a cylinder temperature and 80° C. as a mold temperature, whereby producing each test piece, which was designated as Sample E3.

(Sample E4)

Each test piece made from a polyamide resin composition was produced similarly to Sample E1 except for changing the input ratio of polyamide 66, polyamide 6I/6T, polyamide 12, ethylene-butene copolymer and a talc to that shown in Table 1, and was designated as Sample E4.

(Sample C1)

Using only polyamide 66, a pellet was produced similarly to Sample E1 to obtain each test piece, which was designated as Sample C1.

(Samples C2, C3)

Each test piece made from a polyamide resin composition was produced similarly to Sample E1 except for using no polyamide 12 or ethylene-butene copolymer and changing the input ratio of polyamide 66 and polyamide 6I/6T to that shown in Table 1, and was designated as Sample C2 or C3.

(Sample C4)

Each test piece made from a polyamide resin composition was produced similarly to Sample E1 except for using no ethylene-butene copolymer and changing the input ratio of polyamide 66, polyamide 6I/6T and polyamide 12 to that shown in Table 1, and was designated as Sample C4.

(Sample C5)

Each test piece made from a polyamide resin composition was produced similarly to Sample E1 except for using no polyamide 6I/6T or polyamide 12 and changing the input ratio of polyamide 66 and ethylene-butene copolymer to that shown in Table 1, and was designated as Sample C5.

Then, each of Samples E1 to E4 and Samples C1 t C5 was examined for the resistance to a snow melting salt (calcium chloride resistance), flexural strength and flexural modulus at 120° C., Izod impact strength and viscosity as an index of a molding performance. Each property (physical property) was tested as described below. The results are shown in Table 1.

(Physical Property Evaluation)

(Mechanical Property Evaluation)

The following items and conditions were employed in the evaluation. The evaluation was conducted entirely under dry condition.
(1) Flexural strength and flexural modulus: In accordance with ASTM D790, a strip specimen whose thickness was 6.4 mm was subjected to a three-point bending test in a chamber at 120° C.
(2) Impact strength: In accordance with ASTM D256, a strip specimen whose thickness was 12.7 mm was notched in an afterward fabrication and then examined by an Izod impact testing device at ambient temperature (23° C.)
   (Calcium Chloride Resistance Evaluation)

An ASTM No. 1 testing strip specimen was pretreated by immersing for 8 hours in water at 80° C. After moisture conditioning for 1 hour in a thermostat chamber at 80° C. and 85% RH, the test strip specimen was coated with a saturated aqueous solution of calcium chloride, and then subjected to a heat treatment for 1 hour in a 100° C. oven. One cycle consisting of the moisture conditioning and the heat treatment was repeated until 100 cycles, and the number of cycles causing a crack of the test piece was used as an index. When no crack was formed even at the 100th cycle, then “>100” was designated in Table 1.

(Extrusion Molding Performance Evaluation)

Using a polyamide resin composition pellet to be evaluated, a viscosity at a temperature of 280° C. and a flow rat of 1 to 500 mm/s was measured by Capillograph 1B of TOYO SEIKI Co., Ltd. having a barrel whose length (L) was 350 mm and whose inner diameter (D) was 9.5 mm and a capillary whose length (L) was 10 mm and whose inner diameter (φ) was 1 mm, and the viscosity at 30 mm/s which is a speed suitable for an extrusion molding was employed as an index.

TABLE 1

| | | | | | | Comparatives | | | | |
|---|---|---|---|---|---|---|---|---|---|---|
| | | Examples | | | | Sample | Sample | Sample | Sample | Sample |
| Sample No. | | Sample E1 | Sample E2 | Sample E3 | Sample E4 | C1 | C2 | C3 | C4 | C5 |
| polyamide | polyamide 66 | 65 | 69 | 64 | 62 | 100 | 75 | 65 | 72 | 100 |
| resin | (% by weight) | | | | | | | | | |
| | aromatic polyamide | 31 | 28 | 32 | 34 | — | 25 | 35 | 25 | — |
| | resin | | | | | | | | | |
| | (% by weight) | | | | | | | | | |
| | polyamide 12 | 4 | 3 | 4 | 4 | — | — | — | 3 | — |
| | (% by weight) | | | | | | | | | |

| | | | | | | | | | |
|---|---|---|---|---|---|---|---|---|---|
| impact resistant material | 25 | 11 | 23 | 24 | — | — | — | — | 20 |
| (EBR) | | | | | | | | | |
| (parts by weight) | | | | | | | | | |
| inorganic filler (talc) | — | — | 6.5 | 14 | — | — | — | — | — |
| (parts by weight) | | | | | | | | | |
| flexural strength (120° C.) | 6 | 7 | 7.5 | 8 | 19 | 10 | 9 | 10 | 8 |
| (Mpa) | | | | | | | | | |
| flexural modulus | 160 | 220 | 270 | 320 | 700 | 400 | 340 | 380 | 320 |
| (120° C.) (Mpa) | | | | | | | | | |
| Impact strength (23° C.) | 680 | 180 | 321 | 240 | 58 | 61 | 70 | 60 | 210 |
| (J/m) | | | | | | | | | |
| calcium chloride | >100 | >100 | >100 | >100 | 1 | 96 | >100 | >100 | 1 |
| resistance (cycle) | | | | | | | | | |
| extrusion molding | 3600 | 900 | 3300 | 3500 | 400 | 700 | 700 | 700 | 3700 |
| performance (Pa/s) | | | | | | | | | |

As evident from Table 1 shown above, Sample E1 to Sample E4 all exhibited an extremely excellent calcium chloride resistance (snow melting salt resistance). Samples E1 to Samples E4 had the Izod impact strengths equal or superior to those of Sample C1 to Sample C5. Samples E1 to Samples E4 also had the flexural modulus sufficient to be tolerable when being used practically as an automobile part, for example, and their extrusion molding performances were also satisfactory.

### Example 2

This Example is the production of a coolant pipe as a resin molded article in an automobile engine.

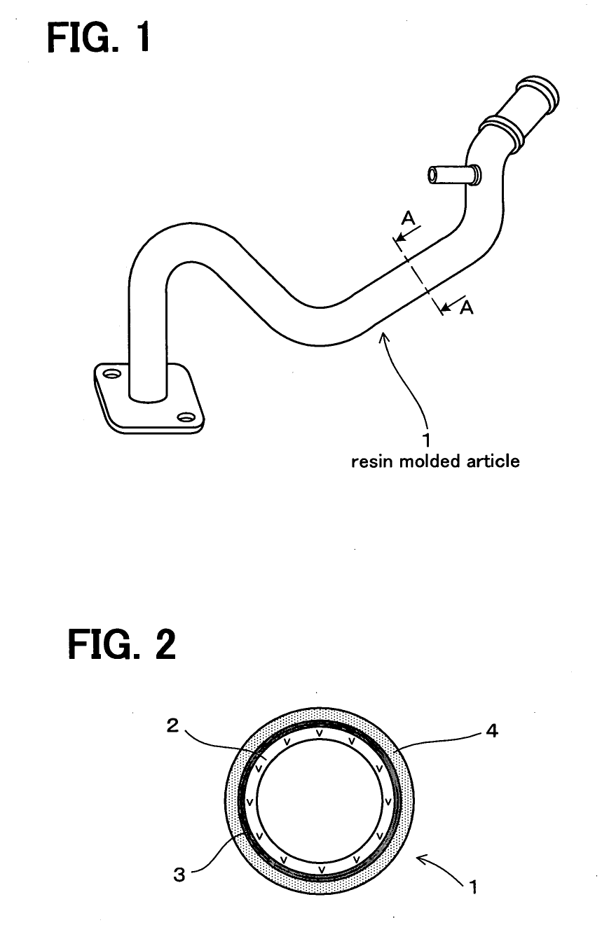

As shown in FIG. 1 and FIG. 2, a resin molded article 1 according to this Example is a coolant pipe in an automobile engine. As shown in FIG. 2, the resin molded article comprises three layers, namely, an inner layer portion 2, an intermediate layer portion 3 and an outer layer portion 4, which were laminated. An outer layer portion which is a material for the outer layer portion 4 exposed on the outermost surface of the resin molded article is made from a polyamide resin. This polyamide resin is identical to Sample E1 in Example 1.

An inner layer portion as a material for the inner layer portion 2 is made from a PPS resin, which is excellent in terms of an anti-LLC property in view of its contact with an engine coolant system, i.e., an antifreeze solution (LLC) whose main ingredient is ethylene glycol, together with a softening agent. The intermediate layer portion 3 is an adhesive layer adhering the inner layer portion 2 to the outer layer portion 4, and made from a resin material which is a mixture of a PPS resin and a polyamide resin together with a softening agent.

A method for producing a resin molded article in this Example is described below.

First, as a material for the inner layer portion, the first resin material was produced by mixing 73 parts by weight of a PPS resin and 27 parts by weight of a softening agent. The softening agent may for example be ethylene/glycidyl methacrylate and an ethylene/propylene copolymer.

Then, as a resin material for the intermediate layer portion, the second resin material was produced by mixing 58 parts by weight of the PPS resin, 21 parts by weight of a polyamide resin and 21 parts by weight of the softening agent whose formulation was similar to that in the first resin material described above.

The third resin material (outer layer portion) was produced similarly to Sample E1 in Example 1.

Then, using a multilayer extruder, The first to third resin materials provided as described above were extruded simultaneously. As a result, a resin molded article 4 (coolant pipe) as a laminate of the inner layer portion 2, the intermediate layer portion 3 and the outer layer portion 4 was produced.

In the resin molded article 1 obtained in this Example, the outer layer portion 4 is made from the outer layer portion whose composition was similar to that of Sample E1 described above. Accordingly, the cooling pipe of this Example is extremely excellent in terms of the resistance to a snow melting salt, and reduces a problematic crack formation due to the snow melting salt.

Obviously, numerous modifications and variations of the present invention are possible in light of the above teachings. It is therefore to be understood that, within the scope of the appended claims, the invention may be practiced otherwise than as specifically described here.

1. A resin molded article having an excellent snow melting salt resistance, the resin molded article comprising:
an outer layer portion comprising 100 parts by weight of a polyamide resin and 3 to 40 parts by weight of an impact resistant material, and,
wherein the polyamide resin essentially consists of 40 to 99% by weight of polyamide 66 and 1 to 60% by weight of an aromatic polyamide resin.

2. A resin molded article according to claim 1, the resin molded article consisting of only the outer layer portion.

3. A resin molded article according to claim 1, the resin molded article comprising a plural layers, an outermost layer thereof consisting of the outer layer portion.

4. A resin molded article according to claim 1, wherein the impact resistant material is an acid-modified ethylene-butene copolymer (EBR), an acid-modified ethylene-propylene copolymer (EPR), an acid-modified ethylene-propylene-diene copolymer (EPDM) or an acid-modified styrene-ethylene-butylene-styrene block copolymer (SEBS).

5. A resin molded article according to claim 1, wherein the outer layer portion further comprises 2 to 150 parts by weight of an inorganic filler.

6. A resin molded article according to claim 5, wherein the inorganic filler is a talc or wallastonite.

7. A resin molded article according to claim 3, wherein the resin molded article is a coolant system part and formed by combining an inner layer portion which is in contact with the coolant and the outer layer portion which is provided outside of the inner layer portion via an intermediate layer portion for adhesion.

8. A resin molded article according to claim 7, wherein the resin molded article is a coolant system part which is in contact with a coolant for cooling an automobile engine.

9. A resin molded article according to claim 7, wherein the resin molded article is an extrusion molded article.

10. A resin molded article according to claim 7, wherein the inner layer portion comprising a polyphenylene sulfide.

11. A resin molded article according to claim 7, wherein the intermediate layer portion comprises a polyphenylene sulfide and a polyamide resin.

12. A resin molded article having an excellent snow melting salt resistance, the resin molded article comprising:
an outer layer portion comprising 100 parts by weight of a polyamide resin and 3 to 40 parts by weight of an impact resistant material, and,
wherein the polyamide resin essentially consists of 40 to 98.5% by weight of polyamide 66, 1 to 59.5% by weight of an aromatic polyamide resin and 0.5 to 20% by weight of polyamide 12.

13. A resin molded article according to claim 12, the resin molded article consisting of only the outer layer portion.

14. A resin molded article according to claim 12, the resin molded article comprising a plural layers, an outermost layer thereof consisting of the outer layer portion.

15. A resin molded article according to claim 12, wherein the impact resistant material is an acid-modified ethylene-butene copolymer (EBR), an acid-modified ethylene-propylene copolymer (EPR), an acid-modified ethylene-propylene-diene copolymer (EPDM) or an acid-modified styrene-ethylene-butylene-styrene block copolymer (SEBS).

16. A resin molded article according to claim 12, wherein the outer layer portion further comprises 2 to 150 parts by weight of an inorganic filler.

17. A resin molded article according to claim 16, wherein the inorganic filler is a talc or wallastonite.

18. A resin molded article according to claim 14, wherein the resin molded article is a coolant system part and formed by combining an inner layer portion which is in contact with the coolant and the outer layer portion which is provided outside of the inner layer portion via an intermediate layer portion for adhesion.

19. A resin molded article according to claim 18, wherein the resin molded article is a coolant system part which is in contact with a coolant for cooling an automobile engine.

20. A resin molded article according to claim 18, wherein the resin molded article is an extrusion molded article.

21. A resin molded article according to claim 18, wherein the inner layer portion comprising a polyphenylene sulfide.

22. A resin molded article according to claim 18, wherein the intermediate layer portion comprises a polyphenylene sulfide and a polyamide resin.
